(19) United States
(12) Patent Application Publication
(10) Pub. No.: US 2007/0137803 A1
(43) Pub. Date: Jun. 21, 2007

(54) Curved window roller blind for motor vehicles

(75) Inventors: Melf Hansen, Gondelsheim (DE); Herbert Walter, Ebersbach (DE); Matthias Maier, Esslingen (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Bos Gmbh & Co. KG, Ernst-Heinkel-Strasse 2 (DE)

(21) Appl. No.: 10/569,365

(22) PCT Filed: Aug. 10, 2004
(86) PCT No.: PCT/EP04/08927

§ 371 Date: Nov. 13, 2006

(30) Foreign Application Priority Data
Aug. 23, 2003 (DE) 103 38 900.8

(51) Int. Cl. B60J 1/20

(52) U.S. Cl. 160/370.22

(57) ABSTRACT

A rear window roller blind for motor vehicles has a curved extension profile and a curved winding shaft, which corresponds in its profile to the curvature of the extension profile. The winding shaft is composed of several winding shaft beads and is supported on an axle so that it can rotate. The course of the axle follows the curvature of the segmented winding shaft. A spring motor is arranged either within the axle or laterally next to the axle.

### BACKGROUND OF THE INVENTION

In order to correspond to the shape of the body of a motor vehicle, the rear window of a motor vehicle is more or less cambered. The greater the camber of the rear window, the greater the distance in the center area between the inside of the rear window and a window roller blind, which travels along a plane. This can be a problem not merely for aesthetic reasons. First and foremost are the spatial conditions in the molded area of the vehicle, which can present problems under these circumstances. The window roller blind must be arranged at a significant distance from the rear window, which significantly reduces head room for the rear passengers. This is a considerable problem particularly with smaller vehicles, in which there is already a notorious lack of room.

Only curving the extension rod to which the roller blind is fixed in the upper area is typically not sufficient to improve the head room. In addition, curving the rod in the upper area would be particularly difficult. It is much more favorable situation if the extension rod has an appropriate curvature adapted to the window from the start. However, a curved extension rod in turn requires a curved extension slot, so that the extension rod can be retracted flush with the parcel shelf at the rear of the vehicle. With such an arrangement, if a straight winding shaft is used, the roller blind would constantly graze the edge of the slot, which is viewed as unfavorable.

Because of these issues, the use of curved winding shafts is also known. One such curved winding shaft is described, for example, in DE 199 00 506. The winding shaft arrangement disclosed in this reference has a rigid carrier axle that is bent according to the curved profile of the moving roller blind. The actual winding shaft, with which the edge of the roller blind is connected, consists of a corrugated tube that sits on the carrier axle so that it can rotate. A helical spring that is used as a spring motor is next to one end of the carrier axle in order to set the tubular roller shaft in rotation in the direction of winding up the roller blind.

In this known arrangement, the corrugated tube consists of plastic, so that there is a risk that the corrugated tube will become significantly torqued relative to the length of the rear window roller blind, for example. The force which must be developed by the spring motor to completely extend the roller blind can be substantial, because otherwise the roller blind may oscillate too much due to vehicle vibrations.

### BRIEF SUMMARY OF THE INVENTION

In view of the foregoing, an object of the invention is to provide a rear-window roller blind for motor vehicles with a curved winding shaft.

The window roller blind of the present invention includes a rigid shaft curved like an arc. The profile of the shaft reproduces the profile of the curvature along which the roller blind is extended.

The actual roller blind shaft, which comprises a combination of several tubular shaft segments, sits on the rigid axle. The inner diameter of the roller blind shaft is significantly greater than the outer diameter of the rigid axle. Bearing elements are arranged between the axle and the roller blind shaft. The bearing elements support the shaft segments on the axle. The individual shaft segments can rotate without jamming even for a large curvature. The individual shaft segments do not have excessive play, which improves the precision of the support and prevents rattling noises. Due to the bearing elements, the point at which the support is realized relative to the corresponding shaft segment can be predetermined exactly. It is advantageous if the bearing elements lie as much as possible next to the front ends of the shaft segments, so that a slight projection can be prevented.

Coupling elements lock the individual shaft segments in rotation with each other. With the aid of a driving device, the winding shaft, which is combined from the individual shaft segments, is set in rotation at least in the wind-up direction of the roller blind.

Advantageously, the rigid shaft acting as a carrier device can comprise a tube. The tube has the advantage of being very resistant to bending and being relatively light weight. In addition, additional parts of the window roller blind can be housed in the tube if necessary.

In order to suspend the axle, it is sufficient if the axle is held directly at only one end. On the other end of the axle, an intermediate bearing in the shape of a rotating bushing can be arranged, in order to connect the parts housed in the interior of the axle to the outer region so that they can rotate.

Each of the shaft segments can be formed by a section of a metal tube. The wall thickness of each of the metal tubes is preferably small relative to the diameter. It has been shown that a wall thickness between 0.8 mm and 1.2 mm is sufficient.

The bearing elements can be formed by projections that project somewhat radially inwards and with which the shaft segments are supported on the axle. These projections are advantageously distributed along the periphery of two circles. One of the circles is arranged in the vicinity of one end and the other circle is arranged in the vicinity of the other end of the corresponding shaft segment.

The projections can be formed in one piece, for example, with corresponding beads being formed in the case of the use of metal pipes. However, if the shaft segments are made from plastic tube sections, the projections can also be formed in one piece. In each case, the height of the projections is such that the relevant shaft segment can rotate on the axle without jamming.

As an alternative to projections, the bearing elements can be formed by bushings, which are inserted at one end into the shaft segments. The bushings contain boreholes that have a smaller diameter in the center of the bushing than at the ends relative to their length. An especially favorable shape of the borehole is achieved when its longitudinal section is biconcave.

In the simplest case, the coupling elements consist of at least one projection extending in the axial direction and a complementary recess in which the projection engages. At each end of a shaft segment, several such pins can be provided. The pins can be distributed equidistantly in the peripheral direction. In between there are gaps, in which the pins of the adjacent shaft segment engage essentially without play. Alternatively, the projections can be formed on one end of the bushing along with corresponding recesses. In such an arrangement, the bushings are locked in rotation in the corresponding shaft segment.

To prevent the roller blind from crumpling, the roller blind can be elastically extendable in the transverse direction.

The driving device for the roller shaft can be formed by a spring motor. The spring motor can comprise a helical spring or a spiral spring. In the case of the helical spring, it is advantageous if the spring motor is housed in the curved axle formed as a tube. To couple the spring motor housed in the winding shaft to the winding shaft, an annular cover is provided on one end of the axle. The annular cover projects with a collar into the carrier tube acting as an axle and whose radially outer collar is locked in rotation with one of the shaft segments. The coupling cover can thus be used simultaneously as a radial bearing for the roller blind shaft.

From the disclosed embodiments, those skilled in the art will readily understand that any number of modifications are possible, whose description would unnecessarily increase the extent of the present application.

Exemplary embodiments of the subject matter of the invention are illustrated in the drawings.

### BRIEF DESCRIPTION OF THE SEVERAL VIEWS OF THE DRAWINGS

FIG. 1 is a partially cutaway perspective view of a rear section of an illustrative motor vehicle having a rear window blind in accordance with the present invention.

FIG. 2 is a front view of the rear window roller blind of FIG. 1.

FIG. 3 is a partial longitudinal section view of one end of the winding shaft and the carrier axle of the rear window roller blind of FIG. 2.

FIG. 4 is a partial longitudinal section view similar to that of FIG. 3 of the opposing end of the winding shaft of the rear window roller blind of FIG. 2.

FIG. 5 is a side view of one of the winding shaft segments of the rear window roller blind of FIG. 2.

FIG. 6 is a front view of the winding shaft segment of FIG. 5.

FIG. 7 is a partially cutaway side view of the winding shaft showing an alternative embodiment of a spring motor.

FIG. 8 is a partially cutaway side view of the winding shaft shown an alternative embodiment for supporting the shaft segments on the axle.

### DETAILED DESCRIPTION OF THE INVENTION

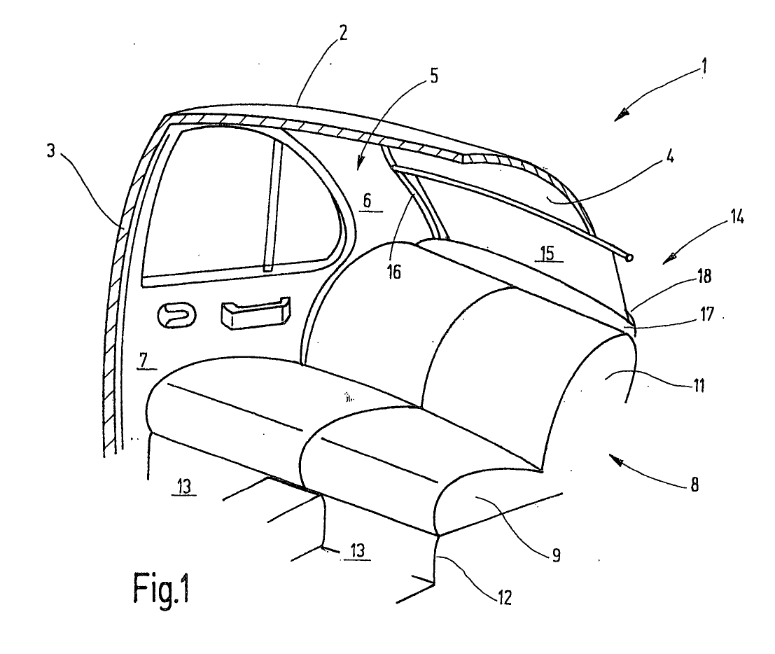

The rear interior area of an exemplary passenger vehicle is shown in FIG. 1. The not shown side of the rear interior area of the vehicle is the mirror image of the illustrated side. The illustration is simplified in that, for example, car body inner structures, such as braces and attachment elements are not shown because their representation is not necessary for understanding the invention.

The illustrated car body section 1 has a roof 2 from the side of which a B-column 3 leads downwards to a floor assembly. A corresponding B-column can be provided on the opposing side of the vehicle. The roof 2 transitions at its rear edge into a rear window 4. The rear window 4 ends at the side at a C-column 5, which is located at a distance to the B-column 3. The C-column 5 carries an inner lining 6. A rear right side door 7 is hinged to the B-column 3 in a known way between the B-column 3 and the C-column 5. A rear seat bench 8 is arranged at the height of the rear right side door 7. The rear seat bench 8 includes a seating surface 9 and also a rear backrest 11. The rear backrest 9 lies on a base surface 12, which belongs to the floor assembly and in which a foot space 13 is formed in front of the rear seating surface 9.

A rear window blind is provided on the inside in front of the rear window 4. In FIG. 1, the partially extended roller blind and also one of the side guide rails 16 of the rear window roller blind 14 can be seen. The guide rails 16 begin at the parcel shelf 17 behind the rear backrest 11 and extend next to the side window edge. In addition, the parcel shelf 17 contains a continuous extension slot 18 from which the roller blind 15 is extended. The extension slot 18 is curved in order to approximate the curvature of the rear window 4.

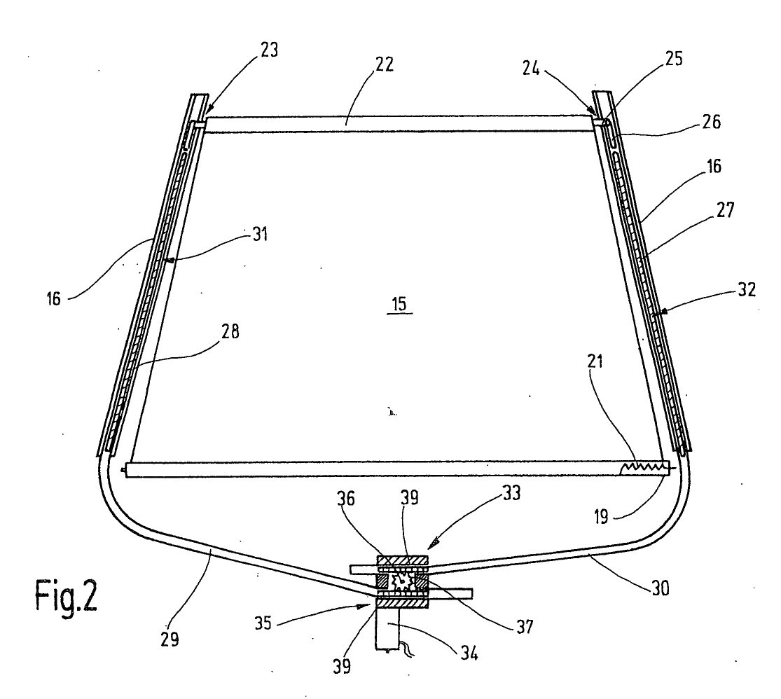

The basic structure of the rear window roller blind 14 is shown in FIG. 2. As shown in FIG. 2, a curved winding shaft 19 is supported below the parcel shelf 17 so that it can rotate. The roller blind 15 is fixed at one edge to the winding shaft 19. The winding shaft 19 is biased with the aid of a schematically shown spring motor 21 in the direction of winding the roller blind 15 onto the winding shaft 19. For this purpose, a helical spring is provided, which is anchored on one end fixed to the car body and is fixed on the other end in the winding shaft 19. The curvature of the winding shaft 19 corresponds to the curvature of the extension slot 18.

The roller blind 15 has an approximately trapezoidal contour and is provided with a flexible tube-like pull 22 on its edge at a distance from the winding shaft 19. An extension rod or hoop in which guide pieces 23 and 24 are telescopically supported is guided through the flexible tube-like pull 22. The guide pieces 23 and 24 have a throat 25 that has a smaller diameter than a guide element 26 that is connected to it and which has the shape of a short cylindrical section. The guide pieces 26 run in the guide rails 16 that are arranged next to the two side edges of the rear window 4.

The bow or the extension rod is curved according to the path of the extension slot 18. Because both the winding shaft 19 and also the extension rod are curved equally, the extended roller blind 15 describes a curved area, whose generatrix is a straight line. The roller blind 15 contacts the edges of the extension slot 18.

Each of the guide rails 16 contains a guide groove 27 that opens in a guide slot 28 in the direction towards the roller blind 15. The bottom end of each guide rail 16 is connected to a guide tube 29, 30, in which two flexible push members 31 and 32 are guided in such a manner that they are resistant to bending. The flexible push members 31 and 32 are so-called Suflex shafts. The flexible members consist of a cylindrical core, which is surrounded by a helical rib. In this way, a type of flexible toothed rack with encircling teeth is produced.

The guide tubes 29 and 30 connect the guide rails 16 to a geared motor 33. The geared motor 33 is assembled from a permanently excited DC motor 34 and a transmission 35 on whose output shaft 36 an end gear 37 is locked in rotation. The gear 37 meshes with the two push members 31 and 32 with a positive fit. These push members 31 and 32 run tangentially past the front gear 37 along diametrically opposite sides and for this purpose are guided in corresponding boreholes 38 and 39.

By setting the geared motor 33 in gear, the push members 31, 32 are selectively pushed forward or pulled back. The guide pieces 23 and 24 follow the movement of the push members 31, 32. The guide pieces are held in contact against the free ends of the push members 31, 32, which are located in the guide grooves 27, with the aid of the spring motor 21.

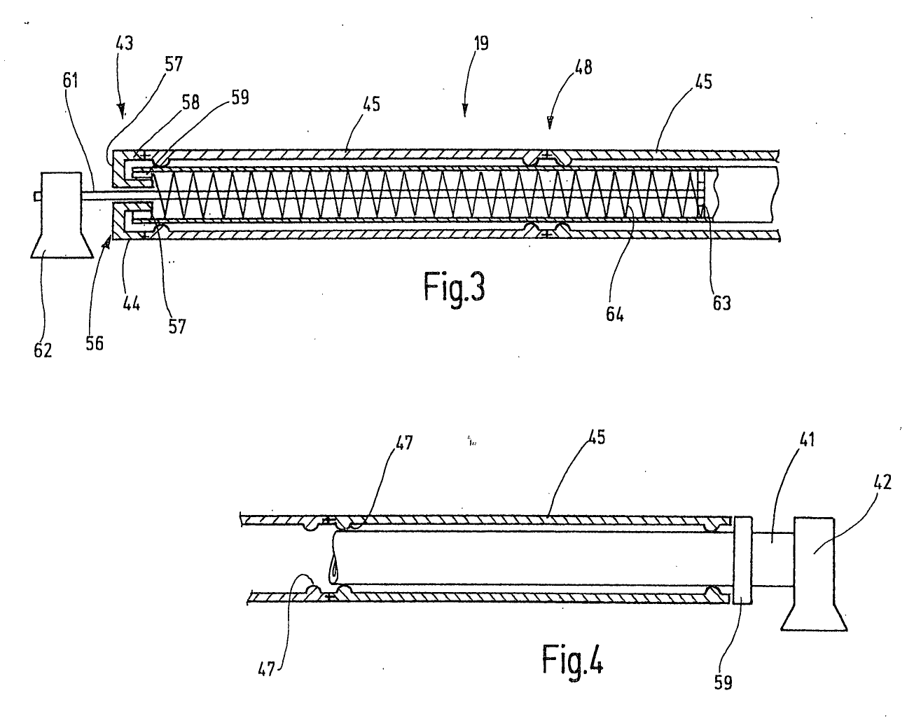

The construction of the winding shaft is described below with reference to FIGS. 3 to 6. As shown in FIGS. 3 and 4, a curved axle 41 is associated with the winding shaft arrangement 19. The curved axle 41 has one end anchored fixed in a bearing block 42 and whose other end is supported loosely at 43. The winding shaft arrangement 19 further includes a loose, rotating cover 44 on the end 43, and also several winding shaft segments 45.

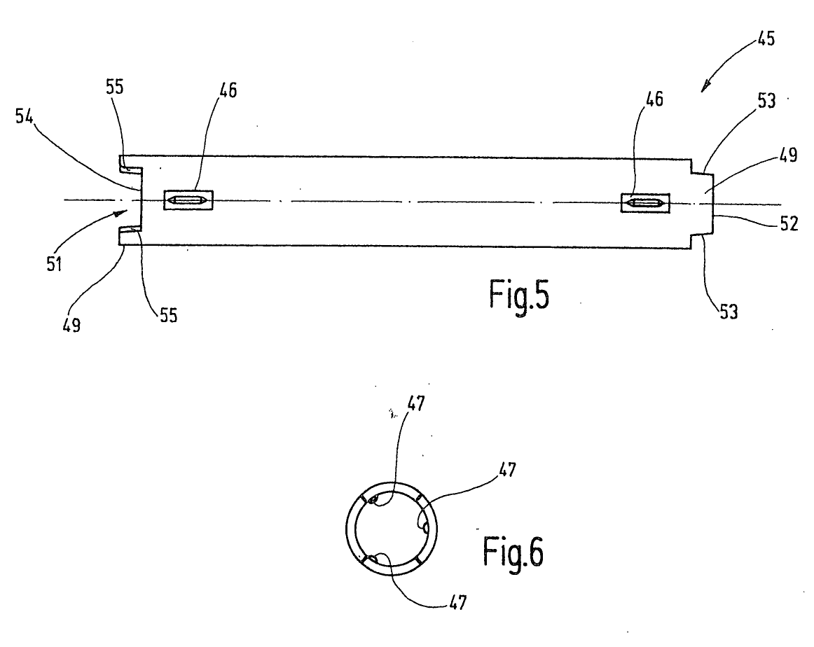

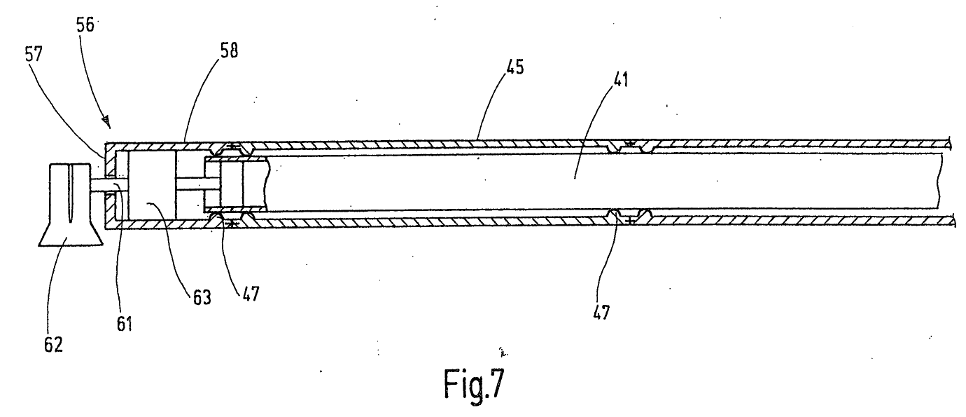

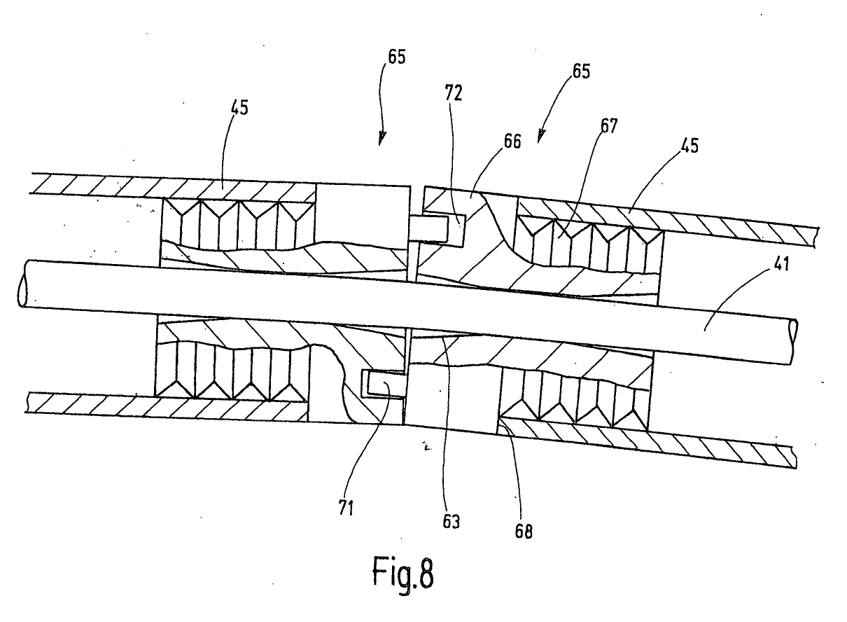

As best shown in FIGS. 3 and 4, the winding shaft 19 is composed of several winding shaft segments 45 arranged one next to the other in the axial direction. Each winding shaft segment 45 comprises, for example, a thin-walled metal tube. The construction of the metal tube, which represents the winding shaft segment 45, is shown in detail in FIGS. 5 and 6.

For producing the winding shaft segment 45, a total of six beads 46 are formed in the tube. Each bead is arranged along the periphery of two circles. One circle is located next to the left end of the winding shaft segment 45 and the other next to the right end. Based on the beads 46, radially inwards projecting knobs 47 are produced, as can be seen from FIG. 6. The peaks of the knobs 47 describe a circle having a diameter that is smaller than the inner diameter of the metal tube from which the winding shaft segment 45 is produced.

The winding shaft segments 45 are coupled to each other by means of coupling elements 48. The coupling elements 48 comprise projections 49 and recesses 51 lying therebetween. The projections 49 exhibit approximately the dimensions of the recesses 51 in the axial and peripheral directions. Each projection 49 is limited by a flat end surface 52 and also two edge surfaces 53 that extend at a small angle relative to each other. The two edge surfaces are oriented so that the projections 49 narrow in the direction towards their distal end.

The recesses 51, which, as mentioned, are shaped somewhat complementary, are limited by a base surface 54 and also two side surfaces 55 extending at a small angle to each other. The recesses 55 diverge at their distal end. Based on the unique configuration, a projection 49 and a recess 51 alternate at each end. This shape can also be considered as teeth on the front end, comprising teeth and teeth gaps lying between. The exact dimensioning of the projections 49 and the recesses 51 is produced from the functional description provided below.

The individual winding shaft segments 45 are placed on the rigid axle 41, which has a bend corresponding to the bend of the extension slot. In this way, a curved winding shaft 19 is obtained, which also follows the path of the extension slot 18. The axle 41 is used as a support or carrier for the winding shaft segments 45, which are supported and held in this way so that they can rotate with the desired curve. The winding shaft segments 45 thus form a coupled tube, with which the course of the extension slot 18 is approximated in the form of a polygon. Here, the knobs 47 represent the bearing elements, which interact with the outer surface of the axle 41 as a sliding point or sliding surface. The knobs bridge the tubular gap between the inside of the winding shaft segments 45 and the outside of the axle 41. In this way, jamming of the straight winding shaft segments 45 on the bending axle 41 in a center region is also effectively prevented. Because the knobs are arranged in the area of the ends of the winding shaft segments 45, the knobs also simultaneously define exact bearing points and compensate for the difference in the polygonal course of the chain of winding shaft segments 45 and the continuously curved profile of the axle 41.

As can be further seen from FIG. 5, with adjacent winding shaft segments 45, the projections 49 of one winding shaft segment 45 engage between the recesses or intermediate spaces 51 of the adjacent winding shaft segment 45 and vice versa. Because the teeth are distributed uniformly and the closest neighbor lies on the inside of the arc-shaped course of the axle 41, the use of, for example, two projections 49 at the latest after a quarter-turn ensures favorable low-play or play-free relationships in terms of the coupling play between adjacent winding shaft segments 45. The play-free coupling in the peripheral direction also results from the circumstance that each projection or tooth 49 penetrates the recess 51 of the adjacent winding shaft segment 45 at the deepest at the inside of the curvature of the axle 41. Due to the equidistant distribution, the same relationships are achieved if for the adjacent winding shaft segment 45 its projection penetrates the recess of the previously considered winding shaft segment 45. The special configuration of the projections 49 and the recesses 51 leads to an especially low-play coupling between adjacent winding shaft segments 45, and thus to an especially low torque on the winding shaft 19 if one of its ends receives a torque and the other is fixed.

The axle 41 is formed as a tube and held rigidly in the bearing block 58 at its right end with reference to FIG. 4. Directly next to the bearing block 58 there is an adjustment ring 59 that guides the adjacent winding shaft segment 45 in the axial direction. The other end of the axle 41 (shown in FIG. 3), which corresponds, for example, to the right end of the winding shaft 19 relative to the orientation in the vehicle, is supported loosely as shown.

The driving of the winding shaft segments 45 occurs above the cover 44. The cover 44 has a substantially annular shape with a base 56 and two collars 57 and 58 projecting from the base 56. The collar 57 projects into the tubular axle 41 and is supported there essentially without play so that it can rotate, for example, with the intermediate arrangement of a plastic ring 59. The radially outer collar 58 has a diameter like the winding shaft segments 45 and is provided with complementary teeth, similar to the teeth provided at one end of each winding shaft segment 45. In this way, the cover 56 is locked in rotation with the winding shaft segment 45 shown at the left in FIG. 3.

Through the borehole of the annular cover 56, another axle 61 with a smaller diameter is guided. The other axle 61 is supported rigidly in a bearing block 62. The axle 61 has a diameter so that the cover 56 is supported so that it can rotate with only minimal radial play. Incidentally, the axle 61 projects past the cover 56 into the interior of the tubular axle 41. At the free end of the axle 61 is a disk 63, with which the axle 61 is supported in the axle 41. The disk 63 is used simultaneously as an abutment for a helical spring 64, which comprises the spring motor 22. The other end of the helical spring 64 is fixed to the inner collar 57 of the cover 56. The cover 56 is fixed in the axial direction relative to the axle 41 so that it cannot be decoupled from the winding shaft segments 45.

The roller blind 15, which is extendable in the direction parallel to the longitudinal extent of the winding shaft arrangement 19, is fixed to the winding shaft segments 45. In this way, the cloth roll made from the roller blind 15 formed on the winding shaft segments 45 extends to the outside of the curvature.

The aforementioned “teeth,” which are provided as coupling devices between adjacent winding shaft segments 45, also have the advantage that there is no continuous gap extending in the peripheral direction between adjacent winding shaft segments 45. Such a gap could entail the risk that when the winding shaft segments 45 rotate, roller blind material penetrates into this gap and becomes jammed for further rotation.

Another embodiment of the spring motor 23 is shown in FIG. 5. The annular cover 56 is formed without the inner collar 57 and instead the outer collar 58 is significantly recessed. In addition, the annular cover 56 is provided with knobs 47, with which it is guided radially on the axial end of the axle 41 in the area of its free end next to the end teeth. In the FIG. 5 embodiment, the cover 56 is used as a spring housing, in which a spiral spring 63 is arranged. The outer spring end of the spiral spring 63 is connected to the cover 56 and the inner end is connected to the axle 61. Therefore, the axle 61 need not have the same length as in the embodiment of FIG. 3, but instead the axle 61 projects only somewhat into the tubular axle 41.

FIG. 6 illustrates an alternative embodiment of the winding shaft segments 45. According to this embodiment, the shaft segments are formed as smooth, cylindrical pipes with smooth ends. A bushing 65 is arranged in each winding shaft segment 45. The bushing is injection-molded from plastic and is composed of a collar 66 and a shaft 67, placed on either side. The collar 66 has the same outer diameter as the outer diameter of the tube, which the winding shaft segment 45 shows. The shaft or pin 67 is placed with a friction fit and locked in rotation in this tube until the collar 66 meets flush with its rear side 68. A borehole 69 passes through the bushing 65 whose longitudinal section, as can be seen from FIG. 6, is biconcave. That is, the diameter of the borehole 69 is smallest in the center relative to the length and increases in the direction towards each axial end of the borehole 69. In this case, the cross section has an approximately circular, curved limiting line on its side edges. The diameter at the smallest point is selected so that the bushing 65 does not jam on the axle 41.

The end side of the collar 66, which points away from the winding shaft segment 45, can be formed in the same way as is explained in connection with FIG. 5. Alternatively, a group of pins 71 can be on the end side, which have a cylindrical shape and which point in the axial direction, as a coupling device. Between every two adjacent pins there is a borehole 72 that receives a pin of the opposite bushing 65.

In terms of play, particularly favorable relationships result when the pins 71 are not exactly cylindrical, but slightly frustum-shaped, such that they narrow away from the bushing 65. In this way, jamming is prevented, while a slight play in the peripheral direction between a pin 71 and a borehole 72 is guaranteed when the pin is inserted to a maximum depth at the inside of the curvature of the axle 41.

A rear-window roller blind for motor vehicles is provided that has a curved extension rod and a curved winding shaft, which, over its course, corresponds to the curvature of the extension rod. The winding shaft is composed of several winding shaft beads and is supported on an axle so that it can rotate. The course of the axle follows the curvature of the segmented winding shaft. A spring motor is arranged either within the axle or laterally next to the axle.

1-26. (canceled)

27. A window roller blind for a motor vehicle comprising:
a rigid axle having a curved arc shape;
a roller blind shaft rotatably support on the axle; the roller blind shaft comprising a plurality of tubular shaft segments, each tubular shaft segment having an inner diameter greater than an outer diameter of the axle;
bearing elements for supporting the shaft segments on the axle;
coupling elements for rotationally locking adjacent shaft segments together;
a roller blind having a first edge fixed to the roller blind shaft and a second edge arranged away from the roller blind shaft; and
a driving device coupled to the winding shaft for rotating the winding shaft in a direction of winding the roller blind onto the winding shaft.

28. The window roller blind according to claim 27 wherein the rigid axle comprises a tube.

29. The window roller blind according to claim 27 wherein the rigid axle is held directly only at one end thereof.

30. The window roller blind according to claim 27 wherein the rigid axle is supported on a bearing axle with a rotating bushing as an intermediate arrangement.

31. The window roller blind according to claim 30 wherein the bearing axle projects a limited distance into the rigid axle.

32. The window roller blind according to claim 27 wherein each shaft segment comprises a section of a metal tube.

33. The window roller blind according to claim 32 wherein each metal tube has a wall thickness that is small relative to the diameter.

34. The window roller blind according to claim 27 wherein the bearing elements comprise projections that project somewhat radially inwards and with which the shaft segments are supported on the axle.

35. The window roller blind according to claim 34 wherein the projections are distributed along the periphery of a first circle and a second circles, the first circle being arranged in the area of one end of the corresponding shaft segment and the second circle being arranged in the area of the opposing end of the corresponding shaft segment.

36. The window roller blind according to claim 35 wherein the first and second circles each have at least at least three associated projections.

37. The window roller blind according to claim 34 wherein the projections are formed in one piece.

38. The window roller blind according to claim 34 wherein the projections comprise embossed beads.

39. The window roller blind according to claim 34 wherein the projections have a height that prevents scraping of the shaft segment on the axle.

40. The window roller blind according to claim 27 wherein the bearing elements comprise bushings, each bushing having an end inserted into the corresponding shaft segment, each bushing has a borehole that has a smaller diameter at ends of the borehole than in the center of the bushing.

41. The window roller blind according to claim 40 wherein a longitudinal section of each borehole has a biconcave shape.

42. The window roller blind according to claim 27 wherein each of the coupling elements comprises at least one projection extending in the axial direction and a complementary recess in which the projection engages.

43. The window roller blind according to claim 42 wherein each of the coupling elements comprises several projections at each end of the corresponding shaft segment, the projections being spaced apart a distance corresponding to a width of the projections in the peripheral direction such that the configuration of the projections at each end of the corresponding shaft segment is the same.

44. The window roller blind according to claim 42 wherein the projections narrow as they extend towards their distal ends.

45. The window roller blind according to claim 42 wherein the projections are formed on an end of the bushing.

46. The window roller blind according to claim 42 wherein the projections are round pins and the recesses are cylindrical boreholes.

47. The window roller blind according to claim 27 wherein the roller blind is elastically extendable in the transverse direction.

48. The window roller blind according to claim 27 wherein the driving device comprises a spring motor.

49. The window roller blind according to claim 27 wherein the driving device includes a helical spring that is arranged in the rigid axle.

50. The window roller blind according to claim 49 wherein a coupling cover is arranged at one end of the roller blind, the coupling cover carrying a radially inner and a radially outer collar projecting in the axial direction, the radially inner collar projecting into the rigid axle and being coupled to the spring, the radially outer collar including coupling elements that are complementary to the coupling elements of the adjacent shaft segment.

51. The window roller blind according to claim 50 wherein the coupling cover defines a radial bearing for the corresponding end of the rigid axle.

52. The window roller blind according to claim 27 wherein the driving device comprises at least one spiral spring.
